(19) United States
(12) Patent Application Publication
(10) Pub. No.: US 2012/0317131 A1
(43) Pub. Date: Dec. 13, 2012

(54) DISASTER RESPONSE SYSTEM

(76) Inventor: Ruth E. Skocic, Garrettsville, OH (US)

(21) Appl. No.: 13/492,537

(22) Filed: Jun. 8, 2012

Related U.S. Application Data
(60) Provisional application No. 61/495,764, filed on Jun. 10, 2011.

(51) Int. Cl. G06F 17/30

(52) U.S. Cl. 707/758; 707/E17.014

(57) ABSTRACT

Health care data and other information about a person is stored in memory accessible to a server. The server allows users to access the health care data and information, such as across a communication network. In some embodiments a biometric identifier for a person is stored with the information. The biometric identifier can be used to control access to a person's records and to quickly locate information associated with a particular person during a disaster.

### CROSS-REFERENCE TO RELATED APPLICATION

This application claims priority to U.S. Provisional Application Ser. No. 61/495,764 filed on Jun. 10, 2011, entitled DISASTER RESPONSE SYSTEM, the disclosure of which is incorporated by reference herein in its entity.

### BACKGROUND

When a disaster occurs, typical emergency systems can be rendered inoperable or unsuitable to respond to the needs under the situation. A large-scale disaster may involve the evacuation or displacement of up to millions of people. In addition, large numbers of injured or dead can strain or completely overwhelm medical response systems. Hospitals, schools, churches and emergency response units may be instantly wiped out when the disaster strikes. Families and friends are often separated.

Oftentimes, disaster victims have no identity cards and may be lost, confused and in shock. When governmental municipalities are wiped out, there is no way of recovering or accessing the lost records. Much of the emergency response teams' time is spent on trying to identify the victims, providing emergency medical care, and attempting to reunite families. Moreover, when injured victims identities are unknown, there is no way of knowing about their medical background. Even if the identities of the victims are known, health records are typically not immediately available to the emergency response teams distributed across the site of the disaster, who may be working in temporary triage tents, in ambulances, and from helicopters.

### SUMMARY

In general terms, this disclosure is directed to a disaster response system. In one possible configuration and by non-limiting example, information including health information is associated with a biometric identifier of an individual. The biometric identifier is used to identify the individual and to access health information of the individual after a disaster.

One aspect is a method of identifying an individual during a mass casualty situation. The method includes acquiring a first biometric identifier of the individual. The method further includes searching a database to identify a second biometric identifier as a match to the first biometric identifier; the second biometric identifier being associated with a user and stored in the database together with information pertaining to the user. The method also includes receiving information of the individual associated with the second biometric identifier from the database.

Another aspect is a method of locating a person missing during a mass casualty situation. The method includes during a preparation period the steps of: registering a user by receiving user data including a first biometric identifier; and storing the user data and the first biometric identifier in a database and associating the first biometric identifier with the user data in the database. The method further includes during the mass casualty situation the steps of: acquiring a biometric identifier of a victim; searching the database to identify the victim by matching the biometric identifier of the victim with the biometric identifier of a user stored in the database; updating the database with a location of the victim; receiving a request of the person missing; searching the database for the location of the victim corresponding to the person missing; and transmitting the location of the person missing in response to the request.

Yet another aspect is a method of responding to a mass casualty situation. The method comprises the steps of: establishing a communication central for coordinating work between a plurality of emergency response functions; connecting the communication central to a server device including a processor and memory, the memory including a database comprising information pertaining to an individual and a biometric identifier of the individual associated with the information; and identifying a victim by acquiring a biometric identifier of the victim and searching the database for a match between the biometric identifier of the victim and the biometric identifier of an individual.

Still another aspect is a disaster response system comprising a server device including a processor and memory, the memory containing a database and instructions executable by the processor to perform a method of identifying an individual during a mass casualty situation, the method comprising the steps of: acquiring a first biometric identifier of the individual; searching a database to identify a second biometric identifier as a match to the first biometric identifier; the second biometric identifier being associated with a user and stored in the database together with information pertaining to the user; and receiving information of the individual associated with the second biometric identifier from the database.

A further aspect is a disaster response system comprising a server device including a processor and memory, the memory containing a database and instructions. executable by the processor to perform a method of locating a person missing during a mass casualty situation. The method includes during a preparation period the steps of: registering a user by receiving user data including a first biometric identifier; and storing the user data and the first biometric identifier in a database and associating the first biometric identifier with the user data in the database. The method further includes during the mass casualty situation the steps of: acquiring a biometric identifier of a victim; searching the database to identify the victim by matching the biometric identifier of the victim with the biometric identifier of a user stored in the database; updating the database with a location of the victim; receiving a request of the person missing; searching the database for the location of the victim corresponding to the person missing; and transmitting the location of the person missing in response to the request.

Yet another aspect is a disaster response system comprising a server device including a processor and memory, the memory containing a database and instructions executable by the processor to perform a method of responding to a mass casualty situation. The method comprises the steps of: establishing a communication central for coordinating work between a plurality of emergency response functions; connecting the communication central to a server device including a processor and memory, the memory including a database comprising information pertaining to an individual and a biometric identifier of the individual associated with the information; and identifying a victim by acquiring a biometric identifier of the victim and searching the database for a match between the biometric identifier of the victim and the biometric identifier of an individual.

Thanks to the provision of a disaster response system which quickly identify disaster victims, the suffering of relatives searching for loved ones is reduced. Also, medical workers are able to get to the medical information of injured victims.

### BRIEF DESCRIPTION OF THE DRAWINGS

FIG. 1 is a schematic block diagram of an exemplary disaster response system according to the present disclosure.

FIG. 2 is a schematic block diagram of an exemplary server of the disaster response system shown in FIG. 1.

FIG. 3 is a functional block diagram of the server shown in FIG. 2.

FIG. 4 is a functional block diagram of an exemplary user system of the disaster response system shown in FIG. 1.

FIG. 5 is a flow chart illustrating an exemplary method of operating a disaster response system according to the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

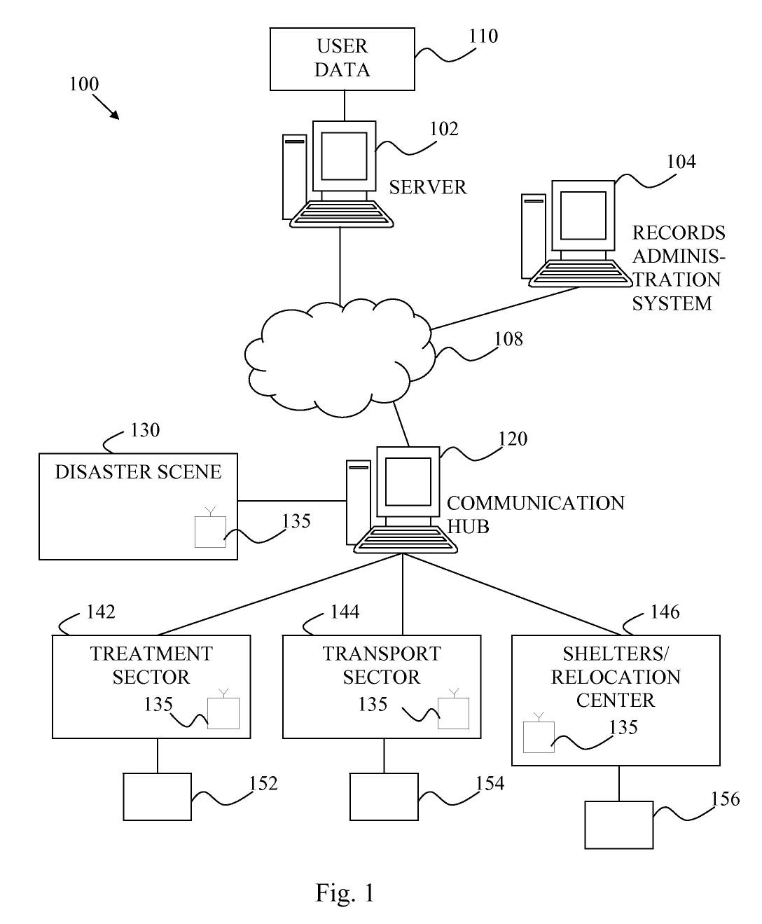

FIG. 1 is schematic block diagram of an exemplary disaster response system 100. System 100 includes server 102, records administrator computing system 104, communication hub 120, disaster scene system 130, treatment sector 142, transport sector 144, and shelter/relocation center sector 146. In some embodiments communication occurs across network 108. Server 102 includes user data 110. Biometric readers 152, 154, and 156 are coupled to treatment sector 142, transport sector 144, and shelter/relocation center sector 146 respectively. In some embodiments, biometric readers are also coupled to the disaster scene 130.

Briefly, some embodiments of disaster response system 100 operate to provide quick and convenient access to user data 110, while protecting the privacy of user data 110 from unauthorized access. For example, health records and information of a person (generally referred to as a “patient” or “victim” herein) are stored in user data 110 of server 102. The disaster response system may be used and set up by local agencies, such as EMA (Emergency Medical Associate), state agencies, such as EOCs (Emergency Operations Centers), and federal emergency management agencies (FEMA), such as FOC (FEMA Operations Center) or DFO (Disaster Field Offices).

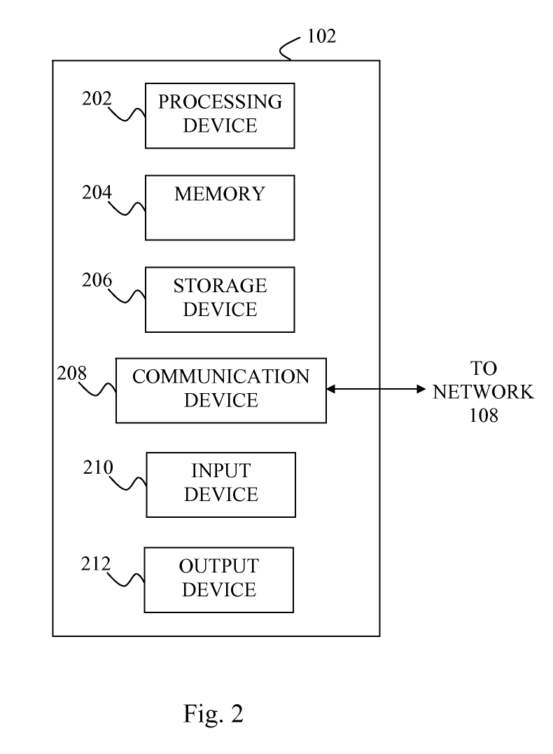

Server 102 is a computing system that stores or is able to access user data 110. Server 102 is in data communication with network 108. In some embodiments server 102 is a Web server that generates data for one or more web pages. The data is communicated across network 108 to a computing system operating a browser software application. An example of server 102 is described with reference to FIG. 2.

In some embodiments server 102 stores user data 110 in memory of server 102. In other embodiments, user data 110 is stored remotely from server 102, but is accessible to server 102, such as across network 108 or another network. In some embodiments user data 110 is stored in a database or other data record.

User data 110 includes information relating to a particular patient or victim. Examples of user data include medical history data (including physician notes, electronic medical records, immunization records, surgical history, medication records, medical treatment records, identification of medical allergies, obstetric history, habit history such as a history of smoking or alcohol abuse, and family medical history), mental health history, social history (including employment history, travel history, family history, and common activities), patient instructions (advance directive, living will, power of attorney for health care), and other data relating to the patient. Due to the confidential nature of user data 110, measures are taken to carefully safeguard user data 110 against unauthorized or improper use. For example, in some embodiments user data 110 is Protected Health Information (PHI) that is managed in compliance with Health Insurance Portability and Accountability Act (HIPAA) standards. Other embodiments conform to other standards, such as one or more ISO standards. In some embodiments, communication of user data 108 is performed in accordance with a secure data communication protocol, such as Secure Sockets Layer (SSL).

Records administrator system 104 is a computing system that operates to allow an administrator to oversee the administration of user data 110 on server 102. In some embodiments system 104 is the same as server 102, but typically system 104 is a separate computing system. Records administrator system 104 is typically operated by person performing as a records administrator.

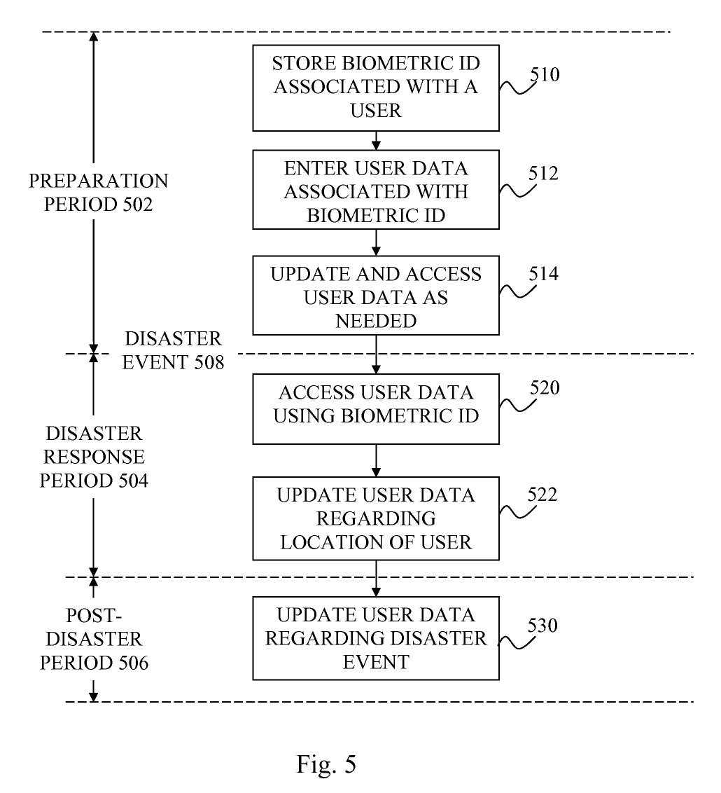

As explained later in conjunction with FIG. 5, the operation involves three periods: a preparation period; a disaster response period; and a post-disaster period. During the preparation period, as much information as possible is gathered into user data 110. People are registered at a large scale, such as entire countries, states, communities, schools, businesses and the like, with the aid of governmental agencies and/or private businesses. The registration stored in user data 110 includes identification data, such as name, address and a biometric identification, as well as crucial health information, such as blood type and major health concerns.

Upon occurrence of a disaster, such as a natural disaster, a man-made disaster, and pandemics, emergency response teams immediately set up communication hub 120 for establishing an infrastructure coordinating efforts between different emergency response functions , such as first responders at the scene of disaster 130, treatment sector 142, transport sector 144 and temporary shelters/relocation centers 146. Internet connectivity is maintained utilizing communication means, such as radio and satellite. Temporary communication towers can be erected to provide wireless communication capability. All those responding to the disaster can be equipped with mobile computing devices 135 providing access to server 102.

Communication hub 120 provides access to server 102 via network 108. The size and functionality of communication hub 120 is triggered by the size and severity of the disaster. Communication hub 120 may be access point to a wide area network (WAN), such as the internet, and to local area networks (LAN).

Treatment sector 142 includes existing hospitals and temporary triage tents where emergency care is provided. Biometric readers 152 are used to read a biometric identifier of found victims (such as the victim's fingerprint). If the disaster victims are already registered in server 102, their biometric identifier can provide immediate access to crucial health information stored in user data 110. If the victims are not registered, emergency response teams at treatment sector 142 or at disaster scene 130 can register those people, including identifying their current location. As a result, the emergency response teams at treatment sector 142 are able to positively identify the victim (particularly if the victim is unable to identify herself) and review the health records of the victim immediately (in “real-time”) to assist them in providing proper medical care to the victim. Similarly, when the victim enters the hospital, the biometric identifier of the victim is read with biometric reader 152 to provide access to the victim's information and medical records.

An example of a biometric reader is a fingerprint scanner. One example of a fingerprint scanner is the U.are.U Fingerprint Reader available from DigitalPersona, Inc. of Redwood City, Calif. Another example of a biometric reader includes a charge coupled device (CCD) for obtaining a digital image of a face, fingerprint, hand, or eye. Other biometric readers are used in other embodiments, such as a voice recognition system, laser, blood analyzer, pulse detector, or keystroke recognition system. In some embodiments multiple biometric readers are used.

Rather than, or in addition to, using a biometric reader, some embodiments include an alternate patient or user identifier. An example of a user identifier is a credit-card type device storing one or more unique identifiers, such as encoding a unique identification number in a magnetic stripe. The credit card can be swiped through a card reader to read the unique identifier. Other identifiers and readers are used in other embodiments, such as a magnetic card and card reader, RFID tag and detector, and the like.

Transportation sector 144 is associated with emergency vehicles, such as ambulances and helicopters. In some embodiments transportation sector 144 communicates wirelessly with communication hub 120 and/or with network 108 with mobile computing devices 135. Examples of mobile computing devices 135 include a laptop computer, a handheld computing system, a tablet computer, a personal digital assistant (PDA), a cell phone, and other computing systems. Examples of wireless communication devices include a radio transceiver, cell phone, wireless modem, satellite communication system, infrared communication system, and other communication systems that communicate using electromagnetic waves. Typically, health care is provided by the emergency vehicles, such as an EMT. Transportation sector 144 access user data 110 from server 102 in some embodiments.

In some embodiments, transportation sector 144 includes biometric readers 154. The biometric readers 154 are configured to read a biometric identifier of a patient or victim and are similar to biometric reader 152 discussed above.

Shelters or relocation centers 146 are established for people that have been displayed by the disaster. At these temporary shelters mobile computing devices 135 are used to update data in server 102, including any important health care information and location of the victims. Each person at shelter 146 is registered into server 102 (if they are not already registered) and the location of each person is identified as being at the particular shelter. If the person is moved to a different shelter, the user data 110 is updated accordingly. If a person has lost a family member or a loved one, a search can be conducted by an authorized person to identify the current location of the loved one (including people or animals).

In some embodiments, shelters or relocation centers 146 include biometric readers 156. The biometric readers 156 are configured to read a biometric identifier of a patient or victim and are similar to biometric reader 152 discussed above.

Mobile computing devices 135 include a laptop computer, cell phone, personal digital assistant, or other computing systems. In some embodiments shelters or relocation centers 146 operate to communicate data across network 108, such as to access patient data 110.

FIG. 2 is a schematic block diagram of an exemplary server 102. Server 102 is a computing system that typically includes a processing device 202, memory 204, a storage device 206, a communication device 208, an input device 210, and an output device 212.

In its most basic configuration, server 102 typically includes processing device 202, memory 204, and communication device 208. Other embodiments include other components, such as illustrated in FIG. 2, or yet other components.

Processing device 202 is a device that processes a set of instructions. One example of processing device 202 is a microprocessor. Alternatively, various other processing devices may also be used including central processing units (“CPUs), microcontrollers, programmable logic devices, field programmable gate arrays, digital signal processing (“DSP”) devices, and the like. Processing devices may be of any general variety such as reduced instruction set computing (RISC) devices, complex instruction set computing devices (“CISC”), or specially designed processing devices such as an application-specific integrated circuit (“ASIC”) device.

Examples of memory 204 include volatile (such as RAM), and non-volatile (such as ROM and flash) memory. In some embodiments, memory 204 is part of processing device 202, while in other embodiments memory 204 is separate from or in addition to that of processing device 202.

In some embodiments, server 102 also includes an additional storage device 206. Storage device 206 stores digital data. For example, some embodiments of server 102 include removable storage or non-removable storage, including, but not limited to, magnetic or optical disks or tape.

Computer storage media includes volatile and nonvolatile, removable and non-removable media implemented in any method or technology for storage of information such as computer readable instructions, data structures, program modules or other data. Memory 204 and storage device 206 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by server 102. Any such computer storage media may be part of server 102.

In some embodiments, memory 204 and/or storage device 206 store data instructions including one or more of an operating system, application programs, other program modules, and program data.

Server 102 also includes communication device 208 that allows server 102 to communicate with other devices, such as across network 112 (shown in FIG. 1). Communications device 208 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Examples of communication media include wired media such as a wired network or direct-wired connection, and wireless media such as acoustic, radio frequency, infrared and other wireless media. The term computer readable media as used herein includes both storage media and communication media.

In some embodiments, server 102 includes one or more input devices 210, such as a keyboard, mouse, pen, voice input device, touch input device, or other input device. Some embodiments include one or more output devices 212, such as a display, speaker, printer, or other output device.

The computing system described above with reference to server 102 is also an example of other computing systems described herein. For example, in some embodiments records administrator computing system 104, and mobile computing devices 135 are also computing systems as described above.

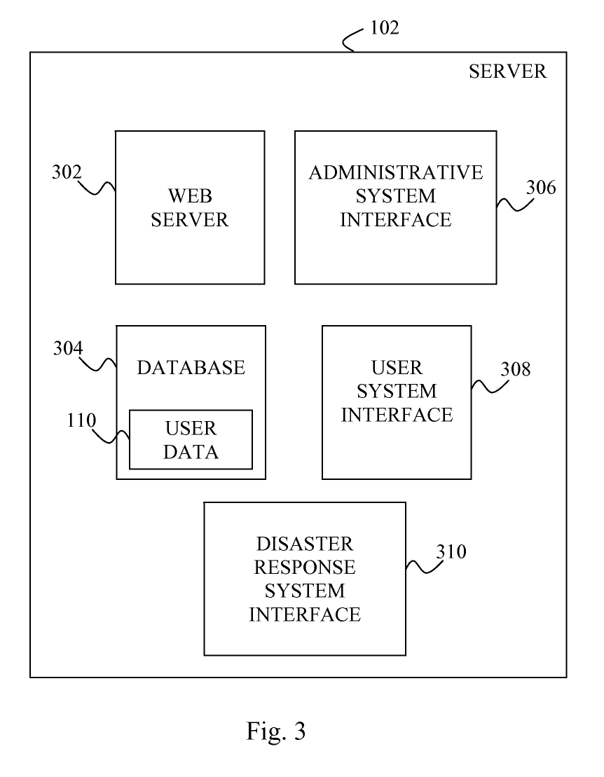

FIG. 3 is a functional block diagram of an exemplary server 102. Server 102 includes Web server 302, database 304, administrative system interface 306, user system interface 308, and disaster response system interface 310. Other embodiments include more or fewer features, functions, or modules.

Web server 302 is a computer program that operates to communicate data defining one or more Web pages, such as across network 108 (shown in FIG. 1). Examples of Web server software applications include Internet Information Services from Microsoft Corporation and Apache HTTP Server. In some embodiments Web server operates to receive Hyper Text Transfer Protocol (HTTP) requests from clients (such as systems 104, or 135) and to serve HTTP responses along with data content, such as Web pages formatted in Hypertext Markup Language (HTML).

Database 304 stores user data 110. User data 110 is typically associated with a single user, such that database 304 includes a plurality of user data records.

In some embodiments server 102 includes separate interface modules for communicating with particular groups of users. For example, server 102 includes administrative system interface 306 for communicating with an administrator (such as through records administrator system 104), or for communicating with disaster scene 130, treatment sector 142, transport sector 144 and temporary shelters/relocation centers 146. It is sometimes desirable to provide separate interfaces for different groups of users, such as to provide different access rights to each group. In some embodiments, system interfaces 306, 308, and 310 are custom software applications that control access rights and define particular Web pages to be displayed to the associated group. In some embodiments, system interfaces 306, 308, and 310 also define one or more communication protocols and operate to communicate data according to the protocols. For example, in some embodiments some or all communication between server 102 and one or more groups of users occurs through one of system interfaces 306, 308, and 310 rather than through Web server 302. In this way, data is communicated between e.g. the disaster scene 130 and server 102 according to a customized or other communication protocol.

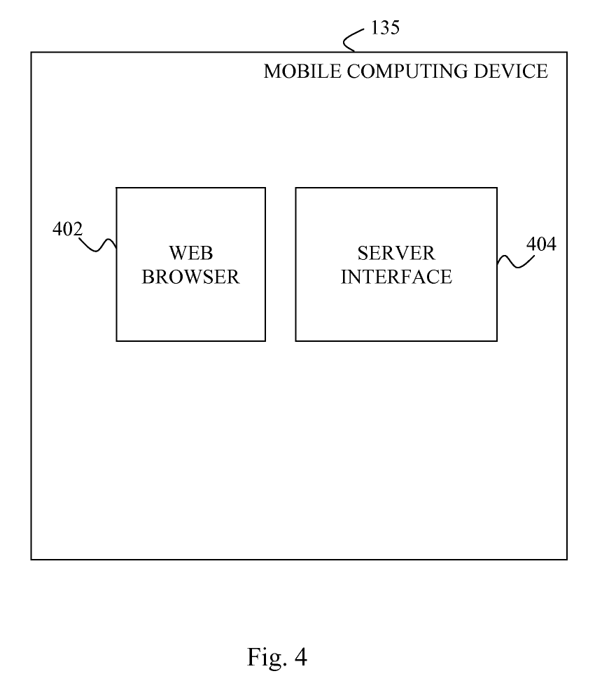

FIG. 4 is a functional block diagram of an exemplary mobile computing device 135. Mobile computing device 135 includes Web browser 402 and server interface 404.

Web browser 402 is a software application operating on mobile computing device 135 that operates to communicate with Web server 302 (shown in FIG. 3), such as to display Web pages from Web server 302. In some embodiments Web browser operates to send HTTP requests to Web server 302 and to receive HTTP responses along with data content from Web server 302. Examples of Web browser 402 include INTERNET EXPLORER® internet browser by Microsoft Corporation and the FIREFOX® Internet browser by the Mozilla Foundation.

In some embodiments mobile computing device 135 includes server interface 404 for communicating with system interface 308 (shown in FIG. 3) of server 102. In some embodiments, server interface 404 is a custom software application that defines one or more communication protocols and operates to communicate data according to the protocols.

The system described above with reference to mobile computing device 135 is also an example of other systems described herein, such as records administrator system 104. In some embodiments these systems include additional modules.

FIG. 5 is a flow chart illustrating an exemplary method 500 of operating a disaster response system. Method 500 includes three periods—a preparation period 502, a disaster response period 504 and a post-disaster period 506. The preparation period 502 and the disaster response period 504 are separated by a disaster event 508. Preparation period 502 includes operations 510, 512, and 514. Disaster response period 504 includes operations 520 and 522. Post-disaster period 506 includes operation 530.

Preparation period 502 begins with operation 510 to store a biometric identifier associated with a user. In some embodiments operation 510 is a user registration process. For example, a fingerprint is scanned and a biometric identifier is generated based on unique features of the fingerprint. The biometric identifier is then stored in memory, such as on a server.

Operation 512 is then performed to enter user information associated with the biometric identifier. For example, the user's name and date of birth are stored in a database record associated with the biometric identifier. In some embodiments, patient data 110 (shown in FIG. 1) is stored in the database and associated with the biometric identifier. In some embodiments operation 512 is performed before operation 510.

After operations 510 and 512, operation 514 is performed to update and access user information as needed. For example, an administrator accesses the user info on server 102 through records administration system 104 (shown in FIG. 1). The administrator is allowed to edit and update some or all of the user information as needed. The administrator also adds additional user information in some embodiments. In some embodiments, as much information as possible is gathered into user data. People are registered at a large scale, such as entire countries, states, communities, schools, businesses and the like, with the aid of governmental agencies and/or private businesses. User data includes identification data, such as name, address and a biometric identification, as well as crucial health information, such as blood type and major health concerns. During the preparation period 502, the entire database may be periodically updated. In some embodiments, a call center contacts each person quarterly to update the information in the database. This ensures that the information stored in the database is correct and up to date.

Disaster event 508 separates preparation period 502 from disaster response period 504. Disaster event 508 is, for example, an event which causes an emergency response team to access user data. Examples of disaster events include a natural disaster, such as an earthquake, a man-made disaster, such as a train accident, and pandemics.

Upon the occurrence of disaster event 508, operation 520 is performed by an emergency response team member to access user data using the biometric identifier of a victim. In some embodiments, operation 520 involves reading a biometric identifier from a victim, such as a fingerprint. The biometric identifier is matched with user data associated with the biometric identifier. The emergency response team member is then given access to the user data associated with the victim. The user data assists the emergency response team member in providing proper health care to the victim.

In some embodiments, health care costs are reduced by preventing improper treatment. For example, if a patient is allergic to a particular drug, allergy information is provided to the emergency response team member so that the emergency response team member does not administer that drug.

In some embodiments, using the biometric identifier provides fast and secure access to patient information that is authenticated as being associated with the victim by using the biometric identifier. As a result, an emergency response team member is able to quickly access the user information needed to provide proper health care.

Operation 522 is then performed to update user data regarding the location of the victim. For example, a emergency response team member at a temporary shelter enters information about the location of the victim arriving at that shelter. Any other user information may be updated as desired during operation 522.

After the immediate disaster response period 504 has completed, post-disaster period 506 begins. Operation 530 includes updating user data regarding the disaster event 508. During this period, the user data is used by physical therapists, caregivers etc. to provide further health care to the patient. In particular, the caregivers can review information about what happened during the disaster for this patient, whether any diagnoses were made or treatment was provided, and review crucial health care information from the various emergency response functions.

Post-disaster period 506 is then concluded, such that method 500 returns to operation 514 of preparation period 502, where patient data is updated or accessed as needed.

The following paragraphs describe several exemplary embodiments according to the present disclosure.

A disaster response system comprising a server device including a processor and memory, the memory containing a database and instructions executable by the processor to perform a method of identifying an individual during a mass casualty situation, the method comprising: acquiring a first biometric identifier of the individual; searching a database to identify a second biometric identifier as a match to the first biometric identifier; the second biometric identifier being associated with a user and stored in the database together with information pertaining to the user; and receiving information of the individual associated with the second biometric identifier from the database.

A disaster response system comprising a server device including a processor and memory, the memory containing a database and instructions executable by the processor to perform a method of locating a person missing during a mass casualty situation, the method comprising: during a preparation period registering a user by receiving user data including a first biometric identifier; storing the user data and the first biometric identifier in a database and associating the first biometric identifier with the user data in the database; during the mass casualty situation acquiring a biometric identifier of a victim; searching the database to identify the victim by matching the biometric identifier of the victim with the biometric identifier of a user stored in the database; updating the database with a location of the victim; receiving a request of the person missing; searching the database for the location of the victim corresponding to the person missing; and transmitting the location of the person missing in response to the request.

A disaster response system comprising a server device including a processor and memory, the memory containing a database and instructions executable by the processor to perform a method of responding to a mass casualty situation, the method comprising: establishing a communication central for coordinating work between a plurality of emergency response functions; connecting the communication central to a server device including a processor and memory, the memory including a database comprising information pertaining to an individual and a biometric identifier of the individual associated with the information; and identifying a victim by acquiring a biometric identifier of the victim and searching the database for a match between the biometric identifier of the victim and the biometric identifier of an individual.

Although the invention has been presented herein to apply to human victims of a disaster, it may very well be used to locate missing animal as well. In such a system, a biometric identifier associated with a particular animal is stored in an animal management system database together with information of that animal.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of identifying an individual during a mass casualty situation, comprising:
acquiring a first biometric identifier of the individual involved in the mass casualty situation;
searching a database to identify a second biometric identifier as a match to the first biometric identifier; the second biometric identifier being associated with a user and stored in the database together with information pertaining to the user; and
receiving at least some of the information pertaining to the individual associated with the second biometric identifier from the database.

2. A method of locating a person missing during a mass casualty situation, comprising:
during a preparation period
registering a user by receiving user data including a first biometric identifier;
storing the user data and the first biometric identifier in a database and associating the first biometric identifier with the user data in the database;
during the mass casualty situation
acquiring a biometric identifier of a victim;
searching the database to identify the victim by matching the biometric identifier of the victim with the biometric identifier of a user stored in the database;
updating the database with a location of the victim;
receiving a request of the person missing;
searching the database for the location of the victim corresponding to the person missing; and
transmitting the location of the person missing in response to the request.

3. A method of responding to a mass casualty situation, comprising:
establishing a communication central for coordinating work between a plurality of emergency response functions;
connecting the communication central to a server device including a processor and memory, the memory including a database comprising information pertaining to an individual and a biometric identifier of the individual associated with the information; and
identifying a victim by acquiring a biometric identifier of the victim and searching the database for a match between the biometric identifier of the victim and the biometric identifier of an individual.
